(19) United States
(12) Patent Application Publication
(10) Pub. No.: US 2017/0037259 A1
(43) Pub. Date: Feb. 9, 2017

(54) ELECTRICALLY CONDUCTING PEDOT SOL-GEL DERIVED COATING

(71) Applicant: SHEFFIELD HALLAM UNIVERSITY, Sheffield (GB)

(72) Inventor: Heming Wang, Sheffield (GB)

(73) Assignee: Sheffield Hallam University, Sheffield (GB)

(21) Appl. No.: 15/304,460

(22) PCT Filed: Apr. 14, 2015
(86) PCT No.: PCT/GB2015/051123

§ 371 Date: Oct. 14, 2016

(30) Foreign Application Priority Data
Apr. 14, 2014 (GB) 1406671.6

(51) Int. Cl. C09D 5/24; C09D 165/00; H01B 1/24; C09D 5/08; H01B 1/08; H01B 1/12

(52) U.S. Cl. CPC C09D 5/24; H01B 1/08; H01B 1/127; H01B 1/24; C09D 5/084; C09D 5/086; C09D 165/00

(57) ABSTRACT

An electrically conducting organic-inorganic sol-gel derived coating. Films are generated exhibiting good electrical conductivity with high resistance to substrate delamination. PEDOT:PSS is used as the conducting polymer dispersed within an organic-inorganic hybrid sol-gel.

### FIELD OF INVENTION

The present invention relates to a transparent or semi-transparent coating configured to be electrically conducting and in particular, although not exclusively to a sol-gel derived coating incorporating an electrically conducting polymer.

### BACKGROUND ART

Optoelectronic devices, such as solar cells, touch panel displays, liquid crystal displays (LCDs), light-emitting diode (LEDs) and detectors are being used in an increasingly diverse range of applications. Typically, such devices comprise a transparent electrode that harvests or emits light. Initially, indium tin oxide (ITO) was the primary material used for the electrode. However, ITO is disadvantageous for a number of reasons including availability, high mechanical brittleness and poor adhesion to organic and other substrate materials. Many materials have been investigated as alternatives for ITO in optoelectronic devices including in particular organic based or carbon derived materials such as polyaniline, polythiophene or carbon graphene. However, it is difficult to fabricate stable inorganic-organic high conducting films using conventional deposition methods without significantly high curing temperatures (typically above 85° C.).

Organic conducting polymers are an attractive class of materials because they combine the properties of electrical conductivity of semiconductors or metals, transparency and flexibility. Poly(3,4-ethylenedioxythiophene) (PEDOT) is among the most promising conducting polymer. However, PEDOT alone is an insoluble polymer in common solvents. This issue was solved by template polymerisation of EDOT with a polyanion, poly(styrene sulfonic acid) (PSSA). PSSA is a charge-balancing dopant added during polymerisation in water which allows for the formation of a colloidal dispersion of PEDOT:PSS. PEDOT:PSS is now commercially available and represent an attractive alternative to ITO. However, certain physical and mechanical properties of a PEDOT:PSS coating are disadvantageous. In particular, the adhesion of the PEDOT:PSS film to a substrate like glass and plastic is very weak and the coating is not water resistant. Such films may be removed or delaminated shortly after immersion in water for example. PEDOT based films are described in a number of publications including: Highly Conductive Poly(3,4-ethylenedioxythiophene):Poly(styrenesulfonate) Films Using 1-Ethyl-3-methylimidaxolium Tetracyanoborate Ionic Liquid (Chantal Badre et al, Adv. Funct. Mater., 2012, 22, 2723-2727); Solution-Processed Metallic Conducting Polymer Films as Transparent Electrode of Optoelectronic Devices (Yijie Xia et al, Adv. Mater., 2012, 24, 2436-2440); Highly conductive PEDOT/silicate hybrid anode for ITO-free polymer solar cells, (Youn Soo Kim et al, Solar Energy Materials and Solar Cells, Vol. 94, Issue 3, March 2010, ISSN 0927-0248 471-477); Highly conductive poly (3,4-ethylenedioxythiophene):poly(styrene sulfonate) films treated with an amphiphilic fluoro compound as the transparent electrode of polymer solar cells (Yijie Xia et al, Energy & Environmental Science, 2012, 5, 5325-5332); Transparent and Conductive Composite of Poly(3,4-Ethylenedioxythiophene) and Silica Sol-Gel Materials (Youngkwan Lee et al, Molecular Crystals and Liquid Crystals Science and Technology. Section A. Molecular Crystals and Liquid Crystals, September 2006, 440-746); Preparation of the thermally stable conducting polymer PEDOT-Sulfonated poly(imide) (Bongkoch Somboonsub et al, Polymer 51, 2010, 1231-1236); Solution-Processable Reduced Graphene Oxide as a Novel Alternative to PEDOT:PSS Hole Transport Layers for Highly Efficient and Stable Polymer Solar Cells (Jin-Mun Yun et al, Advanced materials, 2011, 23, 4923-4928); Development of a simple method for fabrication of transparent conductive films with high mechanical strength (Ichiro Imae et al, Sci. Technol. Adv. Matter, 13, 2012, 045005, 5 pp); Conducting Polymer Growth in Porous Sol-Gel Thin Films: Formation of Nanoelectrode Arrays and Mediated Electron Transfer to Sequestered Macromolecules (Walter J. Doherty III et al, Chem. Mater. 2005, 17, 3652-3660); Highly conductive PEDOT:PSS electrode by simple film treatment with methanol for ITO-free polymer solar cells (Desalegn Alemu et al, Energy Environ. Sci., 2012, 5, 9662-9671); Secondary Dopants Modified PEDOT-Sulfonated Poly(imide)s for High-Temperature Range Application (Suttisak Srisuwan et al, J. Appl. Polym. Sci., 2013, DOI: 10.1002/APP.38593); General Aspects of Tin-Free Antifouling Paints (Iwao Omae et al, Chem. Rev., 2003, 103, 3431-3448).

However, whilst providing satisfactory conductivity performance, such formulations exhibit poor mechanical and physical properties when coated onto different substrates as indicated. Accordingly, there is a need for a transparent or semi-transparent electrically conducting coating suitable for use within optoelectronic devices that solves the above problems.

### SUMMARY OF THE INVENTION

It is an objective of the present invention to provide a transparent or semi-transparent coating exhibiting electrical conductivity suitable for use in electronic applications and in particular optoelectronic devices. It is a further objective to provide a coating that provides good adhesion to a substrate so as to be resistant to moisture or acids and is not readily removed.

The objectives are achieved by combining the electrically conducting properties of a PEDOT based copolymer with a sol-gel derived organic, inorganic or organic-inorganic hybrid sol-gel. Sol-gel technology is a versatile method to form organic, inorganic or organic-inorganic hybrid transparent coatings. In particular, silane based precursors are advantageous to form a sol containing an Si—O—Si bonding structure optionally with attached functional groups that persist after hydrolysis and condensation. Sols are compatible to coat a variety of different substrates and to form gels and solid film either via high temperature or room temperature curing with the resulting coating chemically bonded to the substrate. Accordingly, by incorporating and in particular dispersing the PEDOT based polymer within the sol prior to coating, the as-formed mixture once cured is not readily delaminated on exposure to moisture for example. In particular, by selecting appropriately the components of the sol, an electrically conducting film may be obtained that is curable at less than 100° C. and even at room temperature. Advantageously, a variety of dopant species such as silica-based nanoparticles may be incorporated within the sol to increase the bonding strength and to provide the desired physical and mechanical properties of the coating including in particular flexibility, thickness, toughness and hardness.

According to a first aspect of the present invention there is provided a substrate having a transparent or semi-transparent coating configured to be electrically conducting, the coating comprising: a sol-gel derived organic-inorganic oxide network resultant from condensation reactions of at least one organic and at least one inorganic sol-gel precursor compounds; an electrically conducting polymer comprising poly(3,4-ethylenedioxythiophene) (PEDOT) and a sulfonated polymer incorporated within the network

Preferably, the sulfonated polymer is poly(styrene sulfonate) (PSS) and optionally, poly(3,4-styrene sulfonate), termed poly(styrenesulfonic acid). Alternatively, the sulfonated polymer comprises a sulfonated poly(amic acid) (SPAA) or a sulfonated poly(imide) (SPI). Preferably, the PEDOT:sulfonated copolymer is incorporated within the sol as a colloidal dispersion in water. The dispersion may then be readily combined with a sol to form a mixture that may be easily coated onto a substrate via a plurality of different coating methods including in particular spin-coating, dip-coating, spray-coating as will be appreciated by those skilled in the art.

The sol-gel network may be formed from a variety of different types of sol-gel precursor to selectively achieve the desired chemical, physical and mechanical properties of the coating whilst providing a coating that is chemically bonded to the substrate. Optionally, the resulting sol-gel network may comprise any one or a combination of the following first set of: silicone-oxygen bonds; titanium-oxygen bonds; zirconium-oxygen bonds with any one or a combination of the following second set of: carbon-oxygen, silicone-carbon bonds; titanium-carbon bonds; zirconium-carbon bonds. Optionally, the sol may comprise any one or a combination of various inorganic components including the set of ZrO₂; TiO₂; BeO; SrO; BaO; CoO; NiO; ZnO; PbO; CaO; MgO; CeO₂; Cr₂O₃; Fe₂O₃; Y₂O₃; Sc₂O₃; HfO₂; La₂O₃. The sol may comprise metal oxide gel particulates or nanoparticles such as alumina gel particulates. In particular, the sol may comprise an alumina sol or a silica sol.

Preferably, the sol is formed from organic-inorganic hybrid components. Optionally, the sol may comprise an ormosil or ormosil hybrid. Optionally, the ormosil or ormosil hybrid may be combined with a curing agent optionally applied separately onto the ormosil or ormosil hybrid once coated onto the substrate.

Preferably the organic-inorganic hybrid is formed from a silicate and a silane. Optionally, the sol may comprise an organosilicate and/or a silane precursor including in particular an organosilane. Optionally, the silane comprises any on or a combination of the set of: tetramethoxysilane (TMOS); tetraethoxysilane (TEOS); 3-glycidoxypropylmethoxysilane (GLYMO). Optionally, the silicate comprises any on or a combination of the set of: tetraethoxy orthosilicate (TEOS); methyltriethoxy orthosilicate (MTEOS); phenyltriethoxy orthosilicate (PTEOS); octyltriethoxy orthosilicate (OTEOS); dimethyldiethoxy orthosilicate (DMDEOS); methyltrimethoxy orthosilicate (MTMOS); phenyltrimethoxy orthosilicate (PTMOS); tetramethoxy orthosilicate (TMOS).

Optionally, a curing agent is incorporated in the sol and comprises any once of a combination of any one of triethylenetriamine (TETA); diethylenetriamine (DEA); tetraethylenepentamine (TEPA).

The organic-inorganic hybrid sol-gel is typically formed from at least one organic precursor and at least one inorganic precursor such that the organic and inorganic components are hybridised in the resulting coating structure. That is, the organic and inorganic components are chemically bonded together to create a fully hybridised organic-inorganic structure. The inventors have identified that forming the sol-gel from organic and inorganic precursors enables control of the coating thickness and the required curing temperature. In particular, the present coating may be room temperature cured. The curing temperature is determined, in part, by selecting the type and relative concentrations of the organic and inorganic sol-gel precursors. Using a hybrid inorganic-organic sol-gel system also increases the available methods of coating the substrate.

The inventors have realised that by forming the coating via a sol-gel process using and/or incorporating a polysiloxane, optionally with further precursors such as a silane and/or a silicate, a porous network is created that is facilitates mobility of the PEDOT based conducting polymer once the coating is cured at the substrate. Utilising a polysiloxane precursor, in contrast to a siloxane monomer is advantageous for a number of reasons. In particular, the polysiloxane precursor provides control of coating thickness; increased bonding strength to the substrate; improved flexibility of the coating; a controlled porosity of the network; tailoring of curing temperature and hydrophobicity; and a crack free, non-brittle coating.

The polysiloxane effectively reduces the extent of the condensation reaction and accordingly loss of solvent during the sol-gel process. This provides enhanced coating flexibility and a crack free, non-brittle structure. The coating thickness is controlled as the polysiloxane precursor may be readily cross linked with other components of the system forming part of the resultant network. Cross linking agents and curing agents may be incorporated at the sol-gel stage so as to facilitate network formation during gelation.

The long-chain polysiloxane, being substantially linear, enables control of the porosity. Utilising linear polysiloxane also facilitates cross linking between the Si—O backbone. The physical, mechanical and/or electrochemical characteristics of the coating may be tailored by variation of any one or a combination of i) the concentration of polysiloxane in the coating/sol-gel (and the resulting coating network); ii) the chain length of the polysiloxane; and iii) the extent and nature of functional groups extending from the polysiloxane.

The polysiloxane may comprise function groups/or functionalised side chains extending from the main Si—O backbone. These functional groups and side chains may comprise any oxygen or nitrogen based groups with functionalised side chains comprising for example, acrylic, epoxy or other functionalised groups including organosilanes and/or hybrid organic-inorganic silicate, siloxane and silane compounds.

Optionally, the polysiloxane backbone may comprise the following structure:

—O—[—Si(R)₂—O—Si(R)(R¹)—]ₘ—O—[—Si(R)₂—O—Si(R)(R²)—]ₙ—O—

wherein R, R¹ and R² are organic groups and/or organic polymers and m is 5 to 1000 and n is 5 to 1000.

Preferably, the —Si—O—Si—O—Si—O— bonding is repeated and linear

The synergistic combination of the Si—O and Si—C bonds provides for the possibility of creating thick porous coatings of the order of 100 μm or multiple 100s of μm. Optionally, the thickness of the coating on the substrate is greater than 0.1 μm. Optionally, the thickness of the coating may be between 10 nm to 100 μm.

Optionally, the coating may comprise a dopant species captured or chemically bonded at the hybrid organic-inorganic oxide network. In particular, the present coating is preferably formed by incorporating nano particles at the sol-gel stage of coating formation. The nano particles may comprise a silane, a silicate and/or other dopant particles such as γ-Al₂O₃ and hydroxyapatite. The linear polysiloxanes, within the network are preferably chemically bonded to one another by cross linking agents. The cross linking agents may comprise non-functionalised organic hydrocarbons or functionalised hydrocarbons or other organic, inorganic and/or organic-inorganic cross linking agents. The nano particles incorporated in the sol-gel phase chemically bond to the polysiloxane during the condensation process. The resulting network comprises substantially linear polysiloxane with Si—O repeating units and organic side chains extending from the main Si—O backbone. The organic side chains may comprise any alkyl, aryl and/or mixed alkyl-aryl groups. These alkyl or aryl groups may be substituted with additional functionalised groups along the Si—O backbone, where the functionalised groups comprise any elements selected from periodic table groups 5 to 7 including in particular nitrogen, phosphorus, oxygen, sulphur and chlorine.

Where the organic side group, directly bonded to the Si—O backbone is alkyl, the alkyl group may comprise between 1 to 20 carbon atoms. Optionally, the alkyl, aryl and/or mixed alkyl-aryl groups that are attached directly to the Si—O backbone may be functionalised by comprising nitrogen, phosphorous, oxygen, sulphur and/or chlorine atoms. Optionally, the Si—O backbone may comprise at least one functional side chain bonded directly to either the Si—O backbone or at least one of the alkyl, aryl or alkyl-aryl side groups.

According to the preferred implementation, the polysiloxane is substantially linear. Alternatively, the polysiloxane may be branched at more than one region along the length of the main Si—O backbone. Optionally, the polysiloxane may be a copolymer and in particular an alternating, periodic, statistical, random, block, branched, linear, or graft copolymer formed from polysiloxanes as described herein. Further, the polysiloxane component may comprise a form of polysiloxane including in particular an organopolysiloxane.

In addition to polysiloxane, the present coating may also comprise any of or a combination of the following additional precursors incorporated within the coating network during the sol-gel phase: any organically modified silane selected from the group consisting of alkylsilanes; methyltrimethoxysilane; methyltriethoxysilane; dimethyldiethoxysilane; trimethylethoxysilane; vinyltrimethoxysilane; vinyltriethoxysilane; ethyltriethoxysilane; isopropyltriethoxysilane; butyltriethoxysilane; octyltriethoxysilane; dodecyltriethoxysilane; octadecyltriethoxysilane; aryl-functional silanes; phenyltriethoxysilane; aminosilanes; aminopropyltriethoxysilane; aminophenyltrimethoxysilane; aminopropyltrimethoxysilane; acrylate functional silanes; methacrylate-functional silanes; acryloxypropyltrimethoxysilane; carboxylate; phosphonate; ester; sulfonate; isocyanate; epoxy functional silanes; chlorosilanes; chlorotrimethylsilane; chlorotriethylsilane; chlorotrihexylsilane; dichlorodimethylsilane; trichloromethylsilane; N,O-Bis (trimethylsilyl)-acetamide (BSA); N,O-Bis (trimethylsilyl) trifluoroacetamide (BSTFA); hexamethyldisilazane (HMDS); N-methyltrimethylsilyltrifluoroacetamide (MSTFA); N-methyl-N-(t-butyldimethylsily)trifluoroacetamide (MTBSTFA); trimethylchlorosilane (TMCS); trimethylsilyimidazole (TMSI); and combinations thereof.

The polysiloxane may comprise any one or a combination of the following groups: an alkyl; a substituted alkyl, a halo substituted, an alkenyl, an alkynyl, a halosubstituted alkynyl, a phenyl, a substituted phenyl, a hydroxylic compound. In particular, the polysiloxane may comprise an organofunctionalised group including in particular a hydroxyl, epoxy alkoxy, silanol, amino or isocyanate group. The polysiloxane may comprise a single repeat unit or may be formed as a two, three, four or five component polysiloxane having different respective repeater units forming part of the Si—O part of the backbone. Specifically, and my way of example, the polysiloxane may comprise any one or a combination of the following compounds: Poly[dimethylsiloxane-co-[3-(2-(2-hydroxyethoxy)ethoxy)propyl]methylsiloxane]; Poly(dimethylsiloxane), bis(3-aminopropyl) terminated; Poly(dimethylsiloxane), diglycidyl ether terminated; Poly(dimethylsiloxane)-graft-polyacrylates; Poly[dimethylsiloxane-co-methyl(3-hydroxypropyl)siloxane]-graft-tetrakis(1,2-butylene glycol); Poly[dimethylsiloxane-co-(2-(3,4-epoxycyclohexyl)ethyl)methylsiloxane]; Poly[dimethylsiloxane-co-(3-aminopropyl)methylsiloxane; Poly[dimethylsiloxane-co-methyl(stearoyloxyalkyl)siloxane]; Poly[dimethylsiloxane-co-[3-(2-(2-hydroxyethoxy)ethoxy)propyl]methylsiloxane]; (methacryloxypropyl)methylsiloxane-dimethylsiloxane copolymer; and/or (3-hydroxypropyl) methylsiloxane-dimethylsiloxane copolymer.

The polysiloxane preferably comprises a minimum repeat number of ten and may comprise ten, a hundred, a thousand or tens of thousands of repeat units within a single polymer backbone.

The term ‘alkyl’ refers to a linear, branched, cyclic, or any combination thereof hydrocarbon. The term ‘substituted alkyl’ refers to one or more of the hydrogens on the alkyl group being replaced by another substituent, such as cyano, alkyl, nitro, mercapto, alkylthio, halo, alkylamino, dialkylamino, alkoxy, and tri alkoxysilyl. The term ‘Substituted phenyl’ refers to one or more of the hydrogens on the aromatic ring being replaced by another substituent, such as cyano, alkyl, nitro, mercapto, alkylthio, halo, alkylamino, dialkylamino, and alkoxy.

Optionally, the coating further comprises a corrosion inhibitor. Optionally, the corrosion inhibitor comprises any one or a combination of the following set of: a modified orthophosphate; a polyphosphate; a calcium modified silicone gel; a lithium grease; a synthetic hydrocarbon oil; a mineral oil; an organic molybdenum compound.

Optionally, the corrosion inhibitor comprises any one or a combination of the following set of: a phosphate; a vanadate; a borate; cerium; molybdenum. Preferably, the corrosion inhibitor comprises an organic or inorganic compound. Preferably, the corrosion inhibitor comprises any one or a combination of the following set of: a lithium grease; a synthetic hydrocarbon oil; a mineral oil; an organic molybdenum compound. Preferably, the corrosion inhibitor comprises any one or a combination of the following set of: a silicone based compound; a silica-calcium based compound. Preferably, the corrosion inhibitor comprises any one or a combination of the following set of: a modified orthophosphate; a polyphosphate; a calcium modified silicone gel. Optionally, the corrosion inhibitor may comprise Shieldex (303)® modified silica (SD), Moly-white® 101-ED (Moly) and Heucophos Zapp® (ZAPP); SAP.

Optionally, the coating may further comprise any one or a combination of the following set of: silica based particles; nanofibers or nanoparticles; carbon nanotubes; carbon graphene.

According to a second aspect of the present invention there is provided an optoelectronic device comprising a coated substrate as claimed herein. Optionally, the substrate is configured as an electrode within the device with the present coating is transparent or semi-transparent so as to allow transmission of photons to the PEDOT:sulfonated polymer within the coating.

According to a third aspect of the present invention there is provided a method of coating a substrate with a transparent or semi-transparent electrically conducting coating comprising: preparing an organic-inorganic hybrid sol-gel from at least one organic and at least one inorganic sol-gel precursor compounds; adding a poly(3,4-ethylenedioxythiophene) PEDOT:sulfonated polymer to the sol-gel to form a pre-coating mixture; applying the mixture to a substrate; curing the mixture at the substrate.

Optionally, the step of curing comprises curing at a temperature below 100° C. Optionally, the coating may be cured at room temperature or between 20 to 100° C.

Optionally, a ratio of the PEDOT:sulfonated polymer to sol-gel is (1.5 to 2.5) PEDOT:sulfonated polymer to (0.5 to 1.5) sol-gel.

Optionally, the method may further comprise adding to the sol-gel or mixture any one or a combination of the following set of: silica based particles; HBr; nanofibres or nanoparticles; carbon nanotubes; carbon grapheme; silver based compounds; formic acid; DMSO; Methanol.

According to a fourth aspect of the present invention there is provided a sol-gel based formulation to form a transparent or semi-transparent electrically conducting coating comprising: at least one organic and at least one inorganic sol-gel precursor compounds to form a sol-gel derived organic-inorganic oxide network; and a conducting polymer comprising poly(3,4-ethylenedioxythiophene) PEDOT:sulfonated polymer.

According to a fifth aspect of the present invention there is provided a substrate having a transparent or semi-transparent electrically conducting coating formed by a process of coating the substrate with a formulation comprising: at least one organic and at least one inorganic sol-gel precursor compounds to form a sol-gel derived organic-inorganic oxide network; and a conducting polymer comprising poly(3,4-ethylenedioxythiophene) PEDOT:sulfonated polymer.

### BRIEF DESCRIPTION OF DRAWINGS

A specific implementation of the present invention will now be described, by way of example only, and with reference to the accompanying drawings in which:

FIG. 1 is a photograph of a sol-gel/PEDOT:PSS film on a glass substrate in front of a digital electrometer indicating an electrical resistance of 429Ω;

FIG. 2 are photographs of three sol-gel/PEDOT:PSS films on a glass substrates having the thicknesses 50 nm, 100 nm and 200 nm;

FIG. 3 are transmittance spectra of the three sol-gel/PEDOT:PSS films of FIG. 2 having 50 nm, 100 nm and 200 nm thicknesses;

FIG. 4 is a AFM image of a sol-gel/PEDOT:PSS.

### DETAILED DESCRIPTION OF PREFERRED EMBODIMENT OF THE INVENTION

A sol-gel based system has been developed that in combination with a specific conducting polymer (PEDOT:sulfonated polymer) has been found to provide a transparent or semi-transparent coating having optimised physical, mechanical and electrical characteristics for application as an electrode in optoelectronic devices such as organic solar cells (OSCs), organic light emitting diode (OLEDs), organic photovoltaic devices (OPVs), capacitors, sensors, liquid crystal displays (LCDs), light emitting diodes (LEDs), touch panel displays, lasers, detectors and the like. The present coating may be formed from a variety of different sol precursors including organic, inorganic and organic-inorganic hybrid species. The inventors have identified silica based species as offering the desired physical and mechanical properties to yield a coating that is capable of chemically bonding to the substrate once applied and is resistant to delamination to provide a coating having the desired strength including mechanical toughness, hardness and flexibility.

Various dopant species may be added to the present sols or the pre-coating mixtures in order to optimise the mechanical, physical or electrical properties of the coating as detailed in the following examples.

### Preparation of Pre-Coating Solution

### EXAMPLE 1

A solution was prepared by mixing 1) 20 ml TEOS; 2) 3 ml 3-glycidyloxypropyltrimethoxysilane; 3) 500 μl HNO₃; 4) 40 ml 2-propanol; and 5) 40 ml water; forming approximately 100 ml of a sol.

The as-formed sol was then mixed directly with an aqueous colloidal dispersion of poly(3,4-ethylenedioxythiophene) (PEDOT):poly(styrene sulfonate) (PSS) in the amount 700 ml PEDOT:PSS water solution with 300 ml sol-gel. The PEDOT:PSS aqueous solution was prepared by dissolving 0.08 PEDOT:PSS pellets in a 100 ml.

### EXAMPLE 2

The organic-inorganic hybrid pre-coating mixture was prepared in accordance with example 1. In addition, 10 g poly(dimethylsiloxane) (PDMS) was added to the hybrid sol-gel prior to combining with the PEDOT:PSS solution.

### EXAMPLE 3

The organic-inorganic hybrid pre-coating mixture was prepared in accordance with example 1. In addition, 1.0 weight % silica nano-particles (10 to 20 nm) were added to the final sol prior to mixing with the PEDOT:PSS solution.

### EXAMPLE 4

The organic-inorganic hybrid pre-coating mixture was prepared in accordance with example 1. In addition, a corrosion inhibitor Heucophos Zapp® (ZAPP) (1 to 5 weight %) was added to the sol.

### EXAMPLE 5

The pre-coating mixture was prepared via the sol-gel and the conducting polymer solutions according to example 1. To further enhance the conductivity of the cured coating, a dopant species (0.05 g silver wire) was added to the pre-coating mixture prior to layering onto the substrate and curing. According to further examples, optional and additional conductivity enhancing additives include similar or corresponding amounts of a nano fibres or carbon nano tubes.

### EXAMPLE 6

The pre-coating mixture was prepared via the sol-gel and the conducting polymer solutions according to example 1. To enhance the electrical conductivity, dimethyl sulfoxide (DMSO) (1 to 5 weight % of the pre-coating mixture) was added to the pre-coating mixture.

### EXAMPLE 7

The pre-coating mixture was prepared via the sol-gel and the conducting polymer solutions according to example 1. To enhance the electrical conductivity, HBr (1 to 5 weight % of the pre-coating mixture) was added to the pre-coating mixture.

### Substrate Coating

### Preparation of Thin Films

### EXAMPLE 1

The sol-gel and PEDOT:PSS pre-coating mixture of example 1 was applied onto a glass substrate by spray coating. A strongly bonded electrically conducting film was obtained following curing at 80° C. In a further embodiment and to enhance the electrical conductivity, HBr (100 to 200 ppm concentration and 1 to 5 weight % of the pre-coating mixture) was added to the forming film. A coating was obtained having a coating thickness of 60 to 70 nm.

### EXAMPLE 2

PEDOT:PSS thin films were cast on either polyacrylic plastics (PP) or glass slides (GS) by the spin-coating method at the rpm of 1000 or the spray-coating method. PP or GS were respectively cleaned by soap water, DI water, and isopropanol before applying the thin films. The casted thin films were subsequently cured by placing in an oven at 85° C. for ˜30 min.

Optionally, a multi-layer coating may be provided by sequential coating of further sol-gel based PEDOT:PSS mixtures with multiple curing stages.

### Conductivity Enhancement

Additives such as concentrated sulphuric acid, HBr, HFA, DMSO or methanol may be added to the pre-coating mixture or the sol-gel based film once applied to the substrate prior to curing. Such additives have been found to enhance the conductivity of the final cured coating. The concentration of such additives is dependent on the species of the sol-gel but typically may be 1 to 5 weight % of the pre-coating mixture.

### Characterisation of PEDOT:PSS Sol-Gel Films

The conductivities of the polymer film of example 6 were measured using a two point probe technique with a digital gauge electrometer. Two electrical contacts were made by applying a conducting silver paste on two sides of the PEDOT:PSS sol-gel film on a glass substrate. The morphology of the films was recorded using atomic force microscopy (AFM) in taping mode with a conventional AFM machine-FEI™ Nova NanoSEM and Vecco Nanoscope III AFM. Optical transmittance and absorption spectra of the PEDOT:PSS sol-gel films are measured using a diode array Nicolet Nexue FTIR spectrophotometer.

### Results

### Electrical Conductivity and Resistance

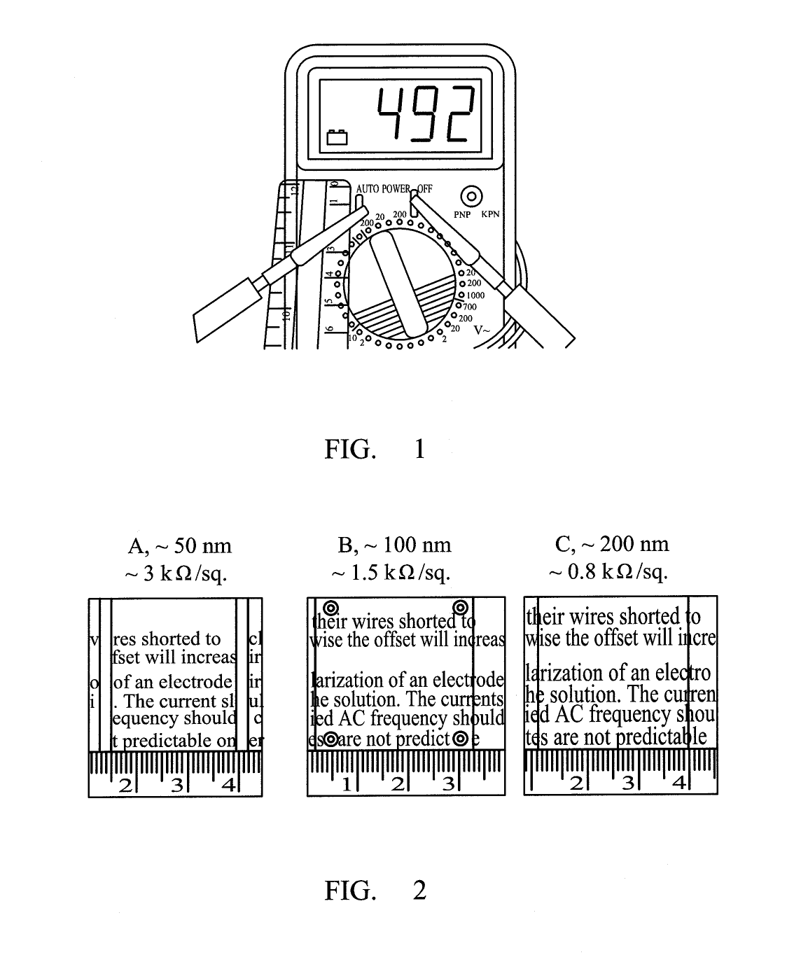

The sol-gel PEDOT:PSS film of 50 to 100 nm thickness on glass exhibited good electrical conductivity (˜1 k Ω/sq) and high transparency (˜90%). The transparent sol-gel/PEDOT:PSS film is illustrated in FIG. 1 with an observed electrical resistance of 429Ω. After immersion in water for one month, a negligible change in electrical conductivity was observed. Accordingly, the as-formed film illustrated good adhesion to the glass substrate was not delaminated or showed any appreciable degradation with water contact.

In a further experiment, PEDOT grade PH1000 was used in place of the standard grade PEDOT of example 6. A significantly reduced sheet resistance was observed being less than 100 Ω/sq for a coating thickness of 50 to 100 nm.

### Transmittance

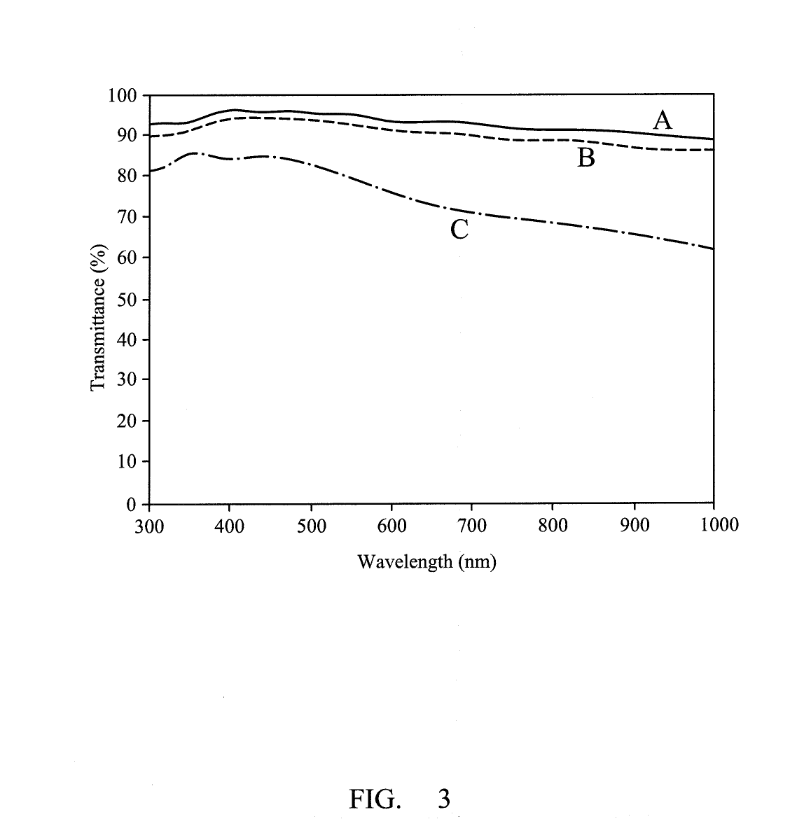

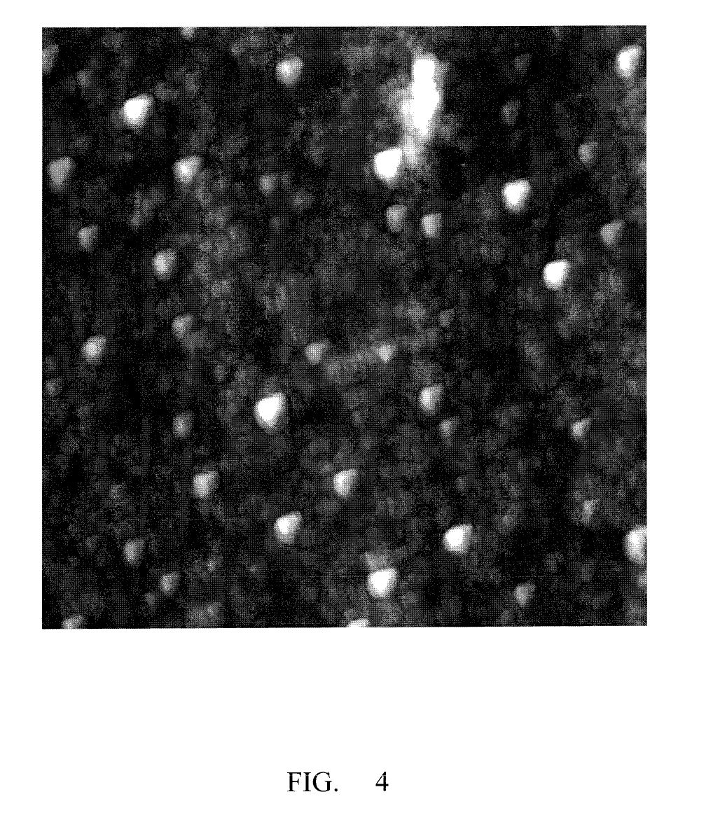

The polymer film produced in accordance with example 6 provided transmittance results as detailed in FIG. 2. Three coating thicknesses were investigated including in particular film thicknesses of 50 nm (A), 100 nm (B) and 200 nm (C). Electrical conductivities of 3 k Ω/sq for coating A, 1.5k Ω/sq for coating B and 0.8 k Ω/sq for coating C) were obtained.

### Morphology

An AFM image of the sol-gel/PEDOT:PSS film of example 6 is shown in FIG. 4. The AFT image suggests an approximate similar size of sol-gel nanoparticles (the bright spot regions) and PEDOT:PSS particles (the darker regions). However, the darker regions may also comprise the sol-gel particles as this cannot be fully distinguished using AFM.

1. A substrate having a transparent or semi-transparent coating configured to be electrically conducting, the coating comprising:
a sol-gel derived organic-inorganic oxide network resultant from condensation reactions of at least one organic and at least one inorganic sol-gel precursor compounds;
an electrically conducting polymer comprising poly(3,4-ethylenedioxythiophene) (PEDOT) and a sulfonated polymer incorporated within the network.

2. The substrate as claimed in claim 1 wherein the sulfonated polymer is poly(styrene sulfonate) (PSS).

3. The substrate as claimed in claim 1 wherein the sulfonated polymer comprises a sulfonated poly(amic acid) (SPAA) or a sulfonated poly(imide) (SPI).

4. The substrate as claimed in claim 1 wherein the sol-gel precursor compounds comprise a silane and a silicate.

5. The substrate as claimed in claim 4 wherein silane comprises any on or a combination of the set of: tetramethoxysilane (TMOS); tetraethoxysilane (TEOS); 3-glycidoxypropylmethoxysilane (GLYMO).

6. The substrate as claimed in claim 4 wherein the silicate comprises any one or a combination of the set of: tetraethoxy orthosilicate (TEOS); methyltriethoxy orthosilicate (MTEOS); phenyltriethoxy orthosilicate (PTEOS); octyltriethoxy orthosilicate (OTEOS); dimethyldiethoxy orthosilicate (DMDEOS); methyltrimethoxy orthosilicate (MTMOS); phenyltrimethoxy orthosilicate (PTMOS); tetramethoxy orthosilicate (TMOS).

7. The substrate as claimed in claim 1 wherein the network comprises a polysiloxane.

8. The substrate as claimed in claim 7 wherein the polysiloxane comprised a linear polysiloxane having a silicone-oxygen backbone.

9. The substrate as claimed in claim 1 wherein the coating further comprises a corrosion inhibitor.

10. The substrate as claimed in claim 9 wherein the corrosion inhibitor comprises any one or a combination of the following set of:
a modified orthophosphate;
a polyphosphate;
a calcium modified silicone gel;
a lithium grease;
a synthetic hydrocarbon oil;
a mineral oil;
an organic molybdenum compound.

11. The substrate as claimed in claim 1 wherein the coating further comprises any one or a combination of the following set of:
silica based particles;
nanofibers or nanoparticles;
carbon nanotubes;
carbon graphene.

12. An optoelectronic device comprising a coated substrate as claimed in claim 1.

13. An optoelectronic device wherein the substrate as claimed in claim 1 is configured as an electrode.

14. A method of coating a substrate with a transparent or semi-transparent electrically conducting coating comprising:
preparing an organic-inorganic hybrid sol-gel from at least one organic and at least one inorganic sol-gel precursor compounds;
adding a poly(3,4-ethylenedioxythiophene) PEDOT:sulfonated polymer to the sol-gel to form a pre-coating mixture;
applying the mixture to a substrate;
curing the mixture at the substrate.

15. The method as claimed in claim 14 wherein the step of curing comprises curing at a temperature below 100° C.

16. The method as claimed in claim 14 further comprising adding a linear polysiloxane to the sol-gel.

17. The method as claimed in claim 14 wherein a ratio of the PEDOT:sulfonated polymer to sol-gel is:
(1.5 to 2.5) PEDOT:sulfonated polymer to (0.5 to 1.5) sol-gel.

18. The method as claimed in claim 14 further comprising adding to the sol-gel or mixture any one or a combination of the following set of:
silica based particles;
HBr;
nanofibres or nanoparticles;
carbon nanotubes;
carbon graphene;
silver based compounds;
formic acid;
DMSO;
Methanol.

19. The method as claimed in claim 14 wherein the sol-gel precursor compounds comprise a silane and a silicate.

20. The method as claimed in claim 14 wherein silane comprises any on or a combination of the set of: tetramethoxysilane (TMOS); tetraethoxysilane (TEOS); 3-glycidoxypropylmethoxysilane (GLYMO).

21. The method as claimed in claim 14 wherein the silicate comprises any one or a combination of the set of: tetraethoxy orthosilicate (TEOS); methyltriethoxy orthosilicate (MTEOS); phenyltriethoxy orthosilicate (PTEOS); octyltriethoxy orthosilicate (OTEOS); dimethyldiethoxy orthosilicate (DMDEOS); methyltrimethoxy orthosilicate (MTMOS); phenyltrimethoxy orthosilicate (PTMOS); tetramethoxy orthosilicate (TMOS).

22. The method as claimed in claim 14 comprising adding a polysiloxane to the organic-inorganic hybrid sol-gel prior to applying the mixture to the substrate.

23. A sol-gel based formulation to form a transparent or semi-transparent electrically conducting coating comprising:
at least one organic and at least one inorganic sol-gel precursor compounds to form a sol-gel derived organic-inorganic oxide network; and
a conducting polymer comprising poly(3,4-ethylenedioxythiophene) PEDOT:sulfonated polymer.

24. A substrate having a transparent or semi-transparent electrically conducting coating formed by a process of coating the substrate with a formulation comprising:
at least one organic and at least one inorganic sol-gel precursor compounds to form a sol-gel derived organic-inorganic oxide network; and
a conducting polymer comprising poly(3,4-ethylenedioxythiophene) PEDOT:sulfonated polymer.
